(19) United States
(12) Patent Application Publication
(10) Pub. No.: US 2020/0073288 A1
(43) Pub. Date: Mar. 5, 2020

(54) REMANUFACTURING METHOD

(71) Applicant: CANON KABUSHIKI KAISHA, Tokyo (JP)

(72) Inventors: Shota Nakamura, Yokohama-shi (JP); Takuya Kawakami, Mishima-shi (JP); Takatoshi Hamada, Mishima-shi (JP); Koichi Ooishi, Mishima-shi (JP); Naoya Asanuma, Susono-shi (JP); Yohei Kusano, Numazu-shi (JP)

(21) Appl. No.: 16/551,925

(22) Filed: Aug. 27, 2019

(30) Foreign Application Priority Data
Aug. 29, 2018 (JP) 2018-160421
Aug. 29, 2018 (JP) 2018-160576

(51) Int. Cl. G03G 15/08

(52) U.S. Cl. CPC G03G 15/0894; G03G 15/0881

(57) ABSTRACT

A remanufacturing method for remanufacturing a second developing device from a first developing device, the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to a first region of the frame with a first adhesive capable of dissolving the frame, and the remanufacturing method including: removing the first cap member from the first region such that a rough surface is formed in the first region; filling the developer accommodating chamber with the developer; and bonding a second cap member different from the first cap member to a second region of the frame different from the first region to seal the opening with the second cap member.

### BACKGROUND OF THE INVENTION

### Field of the Invention

The present invention relates to a remanufacturing method for a developing device and a process cartridge that is equipped with a developer accommodating container and is to be provided in an image forming apparatus.

### Description of the Related Art

In an image forming apparatus using an electrophotographic image forming method (electrophotographic process), an electrostatic latent image is formed on the surface of a photosensitive drum by uniformly charging the photosensitive drum and selectively exposing the charged photosensitive drum. The electrostatic latent image is visualized as a toner image with a toner as a developer. Then, the toner image is transferred to a recording material such as recording paper or a plastic sheet, and heat and pressure are applied to the toner image transferred onto the recording material to fix the toner image on the recording material and perform image recording. Such an image forming apparatus generally requires maintenance of various process means. In order to facilitate the maintenance of various process means, a cartridge system in which the above-described photosensitive drum, charging means, developing means, cleaning means, and the like are grouped in a frame to form a cartridge and which can be detachably attached to the image forming apparatus main body has been put to practical use. The cartridge system makes it possible to provide an image forming apparatus excellent in usability.

With such a cartridge, since the toner is used to form an image on a recording medium, the toner is consumed as image formation is performed. Further, when the toner is consumed to an extent that makes it impossible to form an image of quality that can satisfy the user who has purchased the cartridge, the commercial value of the cartridge is lost. In recent years, cartridges that lost commercial value due to toner consumption have come to be commercialized again. A method for such remanufacturing has been proposed in which a hole is formed in a frame of a toner accommodating container in a cartridge, the toner is refilled through the opened hole, and the hole is sealed with a sealing member after filling (Japanese Patent Application Publication No. 2002-251119). Further, there is a cartridge in which a toner is filled from a toner filling port of a toner accommodating container, and a toner cap is pressed into the toner filling port to seal the toner filling port. A method for remanufacturing the cartridge has also been suggested by which when the toner is refilled, the toner cap attached to the cartridge is removed to fill the toner and a new toner cap is pressed and attached to the cartridge (Japanese Patent Application Publication No. 2002-221855).

There is a cartridge in which a toner filling port is sealed by bonding a toner cap to a toner accommodating container. In the case of such a cartridge, when the toner cap is removed from the adhesive surface to expose the toner filling port, the adhesive surface may be roughened by the adhesion marks remaining on the adhesive surface on the cartridge side. Therefore, when the filling port is closed with a new toner cap or the like, the toner may leak through the rough portion of the adhesive surface. For example, when a new toner cap is bonded to the adhesive surface on the cartridge side, the toner may leak from the cartridge because the new toner cap cannot sufficiently adhere to the rough portion of the adhesive surface.

It is an object of the present invention to resolve the abovementioned problem and provide a remanufacturing method for a developing device and a process cartridge that prevents toner leakage.

### SUMMARY OF THE INVENTION

In order to achieve the object described above, a remanufacturing method for remanufacturing a second developing device from a first developing device,

the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to a first region of the frame with a first adhesive capable of dissolving the frame, and

the remanufacturing method including:

a removing step of removing the first cap member from the first region such that a rough surface is formed in the first region;

a filling step of filling the developer accommodating chamber with the developer; and

a sealing step of bonding a second cap member different from the first cap member to a second region of the frame different from the first region to seal the opening with the second cap member.

In order to achieve the object described above, a remanufacturing method for remanufacturing a second process cartridge from a first process cartridge, the first process cartridge including a developing device including a frame provided with a developer accommodating chamber for accommodating a developer, the frame having an opening for communicating the developer accommodating chamber with the outside of the frame, and a first cap member configured to seal the opening, the first cap member being adhesively bonded to a first region of the frame with a first adhesive capable of dissolving the frame; and an image bearing member configured to bear a developer image, and

the remanufacturing method including:

a removing step of removing the first cap member from the first region such that a rough surface is formed in the first region;

a filling step of filling the developer accommodating chamber with the developer; and

a sealing step of bonding a second cap member different from the first cap member to a second region of the frame different from the first region to seal the opening with the second cap member.

In order to achieve the object described above, a remanufacturing method for remanufacturing a second developing device from a first developing device,

the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to an adhesive surface of the frame with a first adhesive capable of dissolving the frame, and

the remanufacturing method including:

a removing step of removing the first cap member from the adhesive surface such that a rough surface is formed on the adhesive surface;

a filling step of filling the developer accommodating chamber with the developer; and

a sealing step of bonding a sealing member to the adhesive surface with an elastic adhesive having elasticity to seal the opening with the sealing member.

In order to achieve the object described above, a remanufacturing method for remanufacturing a second developing device from a first developing device,

the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to an adhesive surface of the frame with a first adhesive capable of dissolving the frame, and

the remanufacturing method including:

a removing step of removing the first cap member from the adhesive surface such that a rough surface is formed on the adhesive surface;

a filling step of filling the developer accommodating chamber with the developer; and

a sealing step of bonding a sealing member to the adhesive surface with an elastic adhesive having elasticity to seal the opening with the sealing member.

Further features of the present invention will become apparent from the following description of exemplary embodiments (with reference to the attached drawings).

### BRIEF DESCRIPTION OF THE DRAWINGS

FIG. 1A is a perspective view illustrating a remanufacturing method for a developer accommodating container according to a first embodiment;

FIGS. 1B and 1C are cross-sectional views illustrating the remanufacturing method for a developer accommodating container according to the first embodiment;

FIG. 2 is a cross-sectional view of an image forming apparatus according to the first embodiment;

FIG. 3 is a perspective view illustrating mounting of the process cartridge on an image forming apparatus main body according to the first embodiment;

FIG. 4 is a cross-sectional view of a process cartridge according to the first embodiment;

FIGS. 5A and 5B are an exploded view and a perspective view showing the configuration of the developer accommodating container according to the first embodiment;

FIGS. 6A and 6B are front views showing the configuration of a toner cap according to the first embodiment;

FIGS. 7A and 7B are an exploded view and a perspective view showing the configuration of the developer accommodating container according to the first embodiment;

FIG. 8 is an exploded view of the process cartridge according to the first embodiment;

FIGS. 9A and 9B are a perspective view and a cross-sectional view illustrating the disassembling method of the developer accommodating container according to the first embodiment;

FIG. 10 is a perspective view illustrating the remanufacturing method for the developer accommodating container according to the first embodiment;

FIGS. 11A and 11B are a perspective view and a cross-sectional view illustrating the remanufacturing method for the developer accommodating container according to a second embodiment;

FIG. 12A is a perspective view illustrating the remanufacturing method for a developer accommodating container according to a third embodiment;

FIGS. 12B and 12C are cross-sectional views illustrating the remanufacturing method for the developer accommodating container according to the third embodiment;

FIG. 13A is a perspective view illustrating the remanufacturing method for a developer accommodating container according to a fourth embodiment; and

FIGS. 13B and 13C are cross-sectional views illustrating the remanufacturing method for the developer accommodating container according to the fourth embodiment.

### DESCRIPTION OF THE EMBODIMENTS

Embodiments of the present invention will be illustrated below with reference to the drawings. However, the dimensions, materials and shapes of the component parts described in the embodiments, their relative positions and the like should be suitably changed according to the configuration of the apparatus to which the invention is applied and various conditions, etc. The scope of the present invention is not intended to be limited to the following embodiments.

### First Embodiment

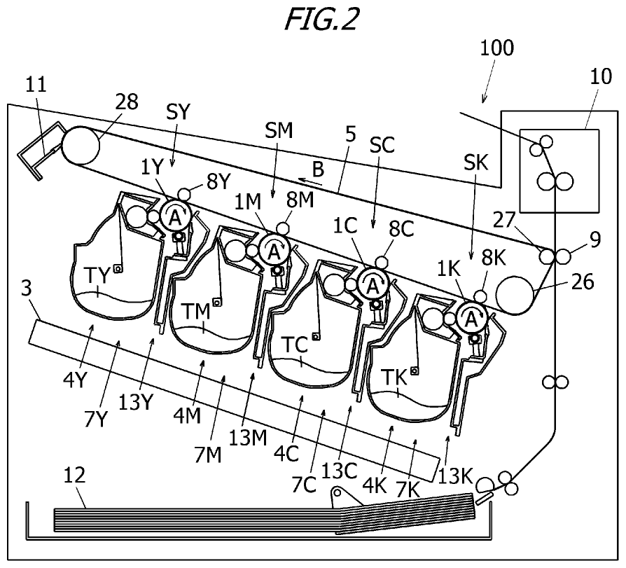

The configurations of the first embodiment of a developing device, a process cartridge 7 and an image forming apparatus 100 according to the present invention will be described with reference to FIGS. 2 to 4.

### Electrophotographic Image Forming Apparatus

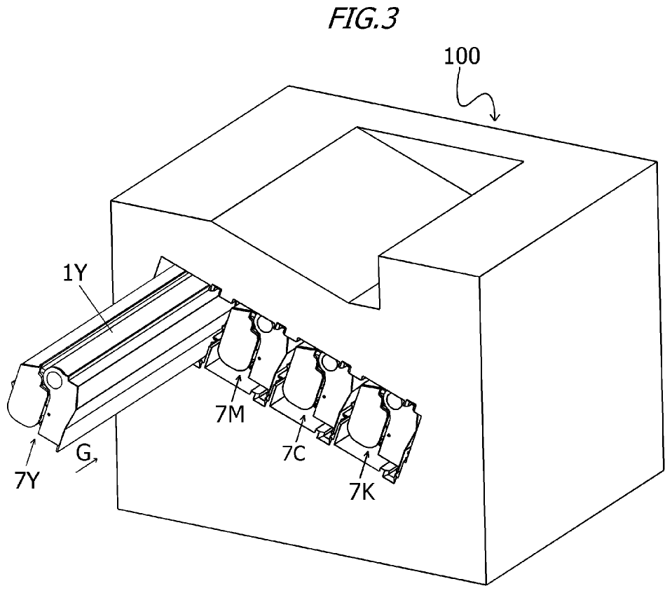

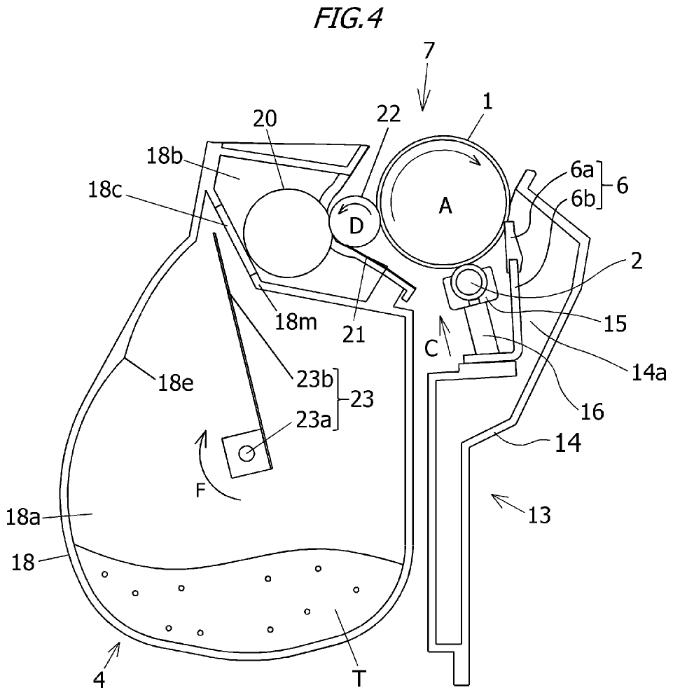

First, the overall configuration of the first embodiment of the electrophotographic image forming apparatus according to the present invention (hereinafter referred to as “image forming apparatus”) will be described with reference to FIGS. 2 to 4. FIG. 2 is a cross-sectional view of the image forming apparatus 100. FIG. 3 is a perspective view illustrating mounting of the process cartridge 7 on the image forming apparatus main body. FIG. 4 is a cross-sectional view of the process cartridge 7. The image forming apparatus 100 includes, as a plurality of image forming units, first, second, third, and fourth image forming units SY, SM, SC, and SK for forming an image of each color of yellow (Y), magenta (M), cyan (C), and black (K), respectively. In the first embodiment, the configurations and operations of the first to fourth image forming units are substantially the same except that the colors of the images to be formed are different. Therefore, hereinafter, Y, M, C, and K will be omitted and the image forming units will be generally described, unless distinction is particularly required. Here, the image forming apparatus 100 is an apparatus for forming an image on a recording medium by using, for example, an electrophotographic image forming process, and is inclusive of, for example, an electrophotographic copying machine, an electrophotographic printer (for example, an LED printer, a laser beam printer, etc.), an electrophotographic facsimile apparatus, etc.

The image forming apparatus 100 has four electrophotographic photosensitive drums (hereinafter referred to as “photosensitive drums”) 1 (1Y, 1M, 1C, 1K) as image bearing members. The photosensitive drum 1 rotates in the direction of arrow A in FIG. 2. A charging roller 2 and a scanner unit 3 are disposed around the photosensitive drum 1. Here, the charging roller 2 is a charging means for uniformly charging the surface of the photosensitive drum 1. The scanner unit 3 is an exposure means for forming an electrostatic image (electrostatic latent image) on the photosensitive drum 1 by irradiating with a laser beam on the basis of image information. Further, around the photosensitive drum 1, a developing device (hereinafter referred to as “developing unit”) 4 (4Y, 4M, 4C, 4K) and a cleaning blade 6 as a cleaning means are disposed. An intermediate transfer belt 5 as an intermediate transfer member for transferring the toner image (developer image) borne by the photosensitive drums 1 to the recording material 12 is disposed opposite to the four photosensitive drums 1. Further, in the first embodiment, a toner T (TY, TM, TC, TK), which is a nonmagnetic one-component developer, is used in the developing unit 4. In the first embodiment, the developing unit 4 brings a developer carrier member (hereinafter referred to as “developing roller”) 22 as a developing means into contact with the photosensitive drum 1 to perform contact development.

A photosensitive unit 13 (13Y, 13M, 13C, 13K) has the photosensitive drum 1, the charging roller 2, the cleaning blade 6, and a waste toner accommodating unit 14a that accommodates the primary transfer residual toner remaining on the photosensitive drum 1. Furthermore, in the first embodiment, a process cartridge 7 (7Y, 7M, 7C, 7K) is configured by integrally forming the developing unit 4 and the photosensitive unit 13 into a cartridge. The process cartridge 7 can be detachably attached to the main body of the image forming apparatus 100 through a mounting means such as a mounting guide and a positioning member (not shown) provided in the image forming apparatus 100. In the first embodiment, as shown in FIG. 3, the process cartridge 7 is detachably attachable to the image forming apparatus 100 along the rotational axis direction (the direction of an arrow G) of the photosensitive drum 1. In the first embodiment, the process cartridges 7 for the respective colors all have the same shape. However, the process cartridge 7 for each color is not limited to such a configuration, and the shapes and sizes of the process cartridges may be different. In the process cartridge 7 for each color, toners T (TY, TM, TC, TK) of each color of yellow, magenta, cyan, and black are accommodated. The process cartridge 7 is also simply referred to as a cartridge.

The intermediate transfer belt 5 is in contact with all the photosensitive drums 1 and moves in the direction of arrow B in FIG. 2. The intermediate transfer belt 5 is stretched around a plurality of support members (a drive roller 26, a secondary transfer opposing roller 27, and a driven roller 28). Four primary transfer rollers 8 (8Y, 8M, 8C, 8K) as primary transfer means are arranged side by side on the inner peripheral surface side of the intermediate transfer belt 5 so as to face the respective photosensitive drums 1. Further, a secondary transfer roller 9 as a secondary transfer unit is disposed at a position facing the secondary transfer opposing roller 27 on the outer peripheral surface side of the intermediate transfer belt 5.

Image Formation Process

At the time of image formation, first, the surface of the photosensitive drum 1 is uniformly charged by the charging roller 2. Next, the surface of the photosensitive drum 1 is scan-exposed by the laser light radiated from the scanner unit 3, whereby an electrostatic latent image according to the image information is formed on the photosensitive drum 1. Next, the electrostatic latent image formed on the photosensitive drum 1 is developed as a toner image by the developing unit 4. The toner image formed on the photosensitive drum 1 is transferred (primary transfer) onto the intermediate transfer belt 5 by the primary transfer roller 8. For example, when forming a full-color image, the above-described processes are sequentially performed in the first to fourth image forming units SY, SM, SC, and SK, and toner images of respective colors are sequentially primary transferred while being superimposed on the intermediate transfer belt 5. Thereafter, the recording material 12 is conveyed to the secondary transfer unit in synchronization with the movement of the intermediate transfer belt 5. Then, the four-color toner image on the intermediate transfer belt 5 is secondarily transferred as a whole onto the recording material 12 by the secondary transfer roller 9 which is in contact with the intermediate transfer belt 5 with the recording material 12 being interposed therebetween.

Thereafter, the recording material 12 to which the toner image has been transferred is conveyed to a fixing device 10 as a fixing means. By applying heat and pressure to the recording material 12 in the fixing device 10, the toner image is fixed to the recording material 12. The primary transfer residual toner remaining on the photosensitive drum 1 after the primary transfer process is removed by the cleaning blade 6. Further, the secondary transfer residual toner remaining on the intermediate transfer belt 5 after the secondary transfer process is removed by the intermediate transfer belt cleaning device 11. The removed secondary transfer residual toner (waste toner) is discharged to a waste toner box (not shown) of the image forming apparatus 100. The image forming apparatus 100 can also form a single-color or multi-color image by using only one or some (but not all) of the image forming parts desired.

Process Cartridge

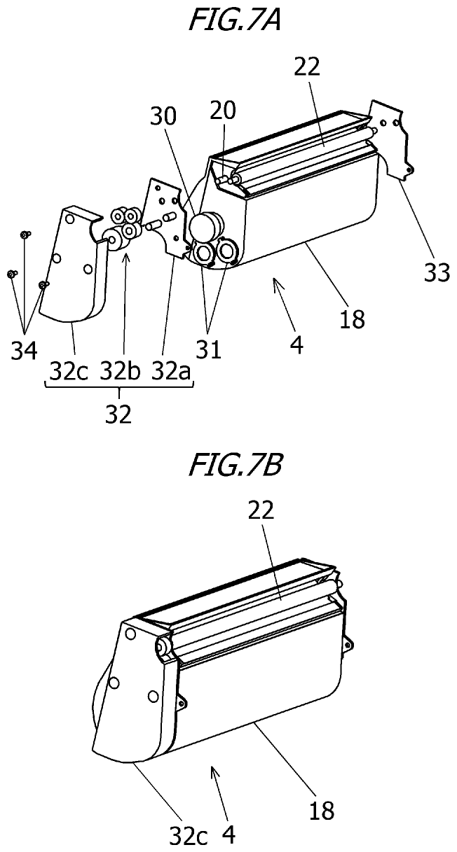

Next, the overall configuration of the process cartridge 7 to be mounted on the image forming apparatus 100 of the first embodiment will be described using FIGS. 4, 7A and 7B. FIG. 7A is an exploded view of the developing unit 4, and FIG. 7B is a perspective view of the developing unit 4. As shown in FIG. 4, the photosensitive unit 13 has a cleaning frame 14 as a frame for supporting various components in the photosensitive unit 13. The photosensitive drum 1 is attached to the cleaning frame 14 rotatably in the direction of arrow A through a bearing member. Further, a charging roller bearing 15 is attached to the cleaning frame 14 along a line passing through the rotation center of the charging roller 2. Here, the charging roller bearing 15 is attached to be movable in the direction of arrow C in FIG. 4. The charging roller 2 is rotatably attached to the charging roller bearing 15. The charging roller bearing 15 is biased toward the photosensitive drum 1 by a charging roller pressure spring 16 as a biasing means.

Further, the cleaning blade 6 has an elastic member 6a for removing the primary transfer residual toner remaining on the surface of the photosensitive drum 1 after the primary transfer, and a support member 6b for supporting the elastic member. The elastic member 6a and the support member 6b are integrally formed. The primary transfer residual toner removed from the surface of the photosensitive drum 1 by the cleaning blade 6 falls in the direction of gravity in the space formed by the cleaning blade 6 and the cleaning frame 14, and is accommodated in the waste toner accommodating unit 14a. As shown in FIGS. 4, 7A and 7B, the developing unit 4 has a developing frame 18 supporting various components in the developing unit 4. The developing unit 4 is provided with a developing roller 22 rotating in the direction of arrow D in FIG. 4 in contact with the photosensitive drum 1. The developing roller 22 is rotatably supported by the developing frame 18 through a first developing bearing unit 32 and a second developing bearing unit 33 at both end portions of the developing roller 22 in the rotational axis direction.

Further, the developing unit 4 has a developer accommodating chamber 18a for accommodating the toner, a developing chamber 18b in which the developing roller 22 is disposed, and an internal opening 18c communicating the developer accommodating chamber 18a with the developing chamber 18b. The internal opening 18c is provided in a partition portion 18m that partitions the developer accommodating chamber 18a and the developing chamber 18b. In the first embodiment, the developing chamber 18b is located vertically above the developer accommodating chamber 18a. A supply roller (developer supply member) 20 rotating in contact with the developing roller 22 and a developer regulating member 21 for regulating the toner layer of the developing roller 22 are disposed in the developing chamber 18b.

The developing frame 18 has the developer accommodating chamber 18a. The developer accommodating chamber 18a of the developing frame 18 is provided with a stiffing member 23 for stirring the accommodated toner T and conveying the toner to the supply roller 20 through the internal opening 18c. The stirring member 23 has a rotating shaft 23a extended in the rotation axis direction of the stirring member 23, and a stirring sheet 23b having one end attached to the rotating shaft 23a. The stirring sheet 23b has a transporting property and stirs and transports the toner. The stirring member 23 rotates in the direction of arrow F in FIG. 4 in a state in which the stirring sheet 23b is in contact with the inner wall surface of the developer accommodating chamber 18a and is flexed. The developer accommodating chamber 18a has a release position 18e at which the stirring sheet 23b is released from the flexed state. When the stiffing sheet 23b passes through the release position 18e, the force with which the stiffing sheet 23b is released from the flexed state causes the toner laying on the stirring sheet 23b to bounce up, and the toner is transported to the supply roller 20 in the developing chamber 18b through the internal opening 18c.

Detailed Configuration of Developer Accommodating Container

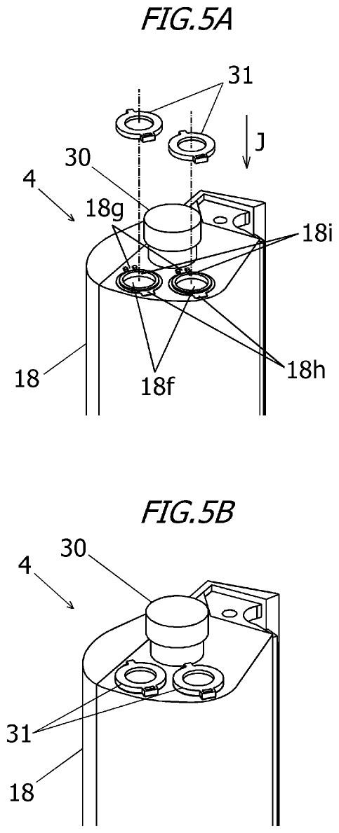

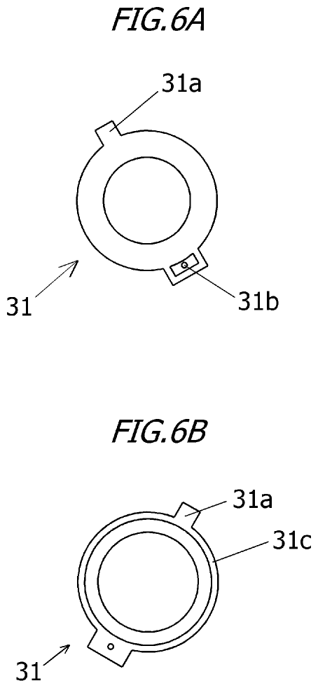

Next, the detailed configuration of the developing frame 18, which is the developer accommodating container, will be described with reference to FIGS. 5A to 7B. FIG. 5A is a perspective view of the developing unit 4 before toner caps 31 (first cap members) are adhesively bonded, and FIG. 5B is a perspective view of the developing unit 4 after the toner caps 31 have been adhesively bonded. FIG. 6A is a front view of the toner cap 31 as viewed in the outside of the developing unit 4, and FIG. 6B is a rear view of the toner cap 31 as viewed in the inside of the developing unit 4. As shown in FIG. 5A, in the state where the developing roller 22 is attached to the developing frame 18, the axial direction of the rotation center of the developing roller 22 is taken as a J direction. In the first embodiment, as shown in FIG. 5A, the developing frame 18 is provided with a stirring gear 30 on one end side in the J direction. The developing frame 18 is also provided with a toner filling port (opening) 18f for filling the developer accommodating chamber 18a with the toner, a frame-side rotation restricting portion 18g, and a frame-side adhesive surface 18h at two locations. Each toner filling port 18f is a through hole and is provided in the developing frame 18 so as to communicate the developer accommodating chamber 18a with the outside of the developing frame 18. The toner filling ports 18f are provided in a side wall disposed at an end portion of the developing frame 18 in the longitudinal direction (the same direction as the axial direction of the developing roller 22) of the developing frame 18. The side wall extends in a direction intersecting the longitudinal direction of the developing frame 18. By disposing the toner filling ports 18f as described above, the toner can be filled up to the vicinity of the end portion of the developer accommodating chamber 18a when filling the toner and also when filling the toner as described hereinbelow.

FIG. 6A shows the toner cap 31 as viewed in the first surface side of the toner cap 31. The first surface of the toner cap 31 faces the outside of the developing unit 4 in a state where the toner cap 31 is attached to the developing unit 4. As shown in FIG. 6A, the toner cap 31 is provided with a cap-side rotation restricting portion 31a and an injection port 31b. FIG. 6B shows the toner cap 31 as viewed in the second surface side of the toner cap 31. The second surface of the toner cap 31 is a surface opposite to the first surface of the toner cap 31 and is a surface facing the inside of the developing unit 4 in a state where the toner cap 31 is attached to the developing unit 4. As shown in FIG. 6B, a cap-side adhesive surface 31c is provided on the second surface of the toner cap 31. The toner caps 31 are mounted by one on each of the two toner filling ports 18f (see FIGS. 5A and 5B). In this case, the cap-side rotation restricting portion 31a is mounted on the frame-side rotation restricting portion 18g, whereby the positional deviation between the toner cap 31 and the developing frame 18 is restricted. For example, the cap-side rotation restricting portion 31a is inserted between a pair of frame-side rotation restricting portions 18g, and the movement of the cap-side rotation restricting portion 31a in the horizontal direction is restricted, thereby restricting the movement of the toner cap 31 in the horizontal direction with respect to the developing frame 18.

As shown in FIG. 5B, the toner cap 31 is mounted on the developing frame 18 in a state where the position of the toner cap 31 is restricted. In the first embodiment, a styrene-based resin composition is used for the toner cap 31 and the developing frame 18. The injection port 31b is a portion into which a terpene-based solvent (solution) having a property of dissolving the styrene-based resin composition is injected. The injection port 31b penetrates the toner cap 31. When the terpene-based solvent (not shown) is injected into the injection port 31b in a state where the toner cap 31 is positioned in the developing frame 18, the terpene-based solvent flows into a space between the frame-side adhesive surface 18h and the cap-side adhesive surface 31c. Then, the terpene-based solvent (first adhesive) dissolves parts of the toner cap 31 and the developing frame 18, and the dissolved parts are then solidified to join the toner cap 31 and the developing frame 18. Thus, the toner cap 31 is adhesively bonded to the frame-side adhesive surface 18h (first region) on the outer surface of the developing frame 18, and seals the toner filling port 18f. As a result, it is possible to suppress the leakage of the toner from the gap between the toner cap 31 and the developing frame 18. Here, the toner cap 31 is a sealing member that seals the toner filling port 18f.

As shown in FIG. 7A, the developing roller 22 and the supply roller 20 are supported in the developing frame 18 through the first developing bearing unit 32 and the second developing bearing unit 33. The first developing bearing unit 32 is configured of a developing bearing member 32a for supporting the developing roller 22 and the supply roller 20, a gear train 32b for transmitting a drive to the stirring gear 30, and a side cover 32c. Further, in the first embodiment, as shown in FIG. 7A, the toner cap 31 is covered by the side cover 32c. The side cover 32c is fixed to the developing frame 18 and the developing bearing member 32a by three screws 34.

Process Cartridge Disassembling Method and Remanufacturing Method

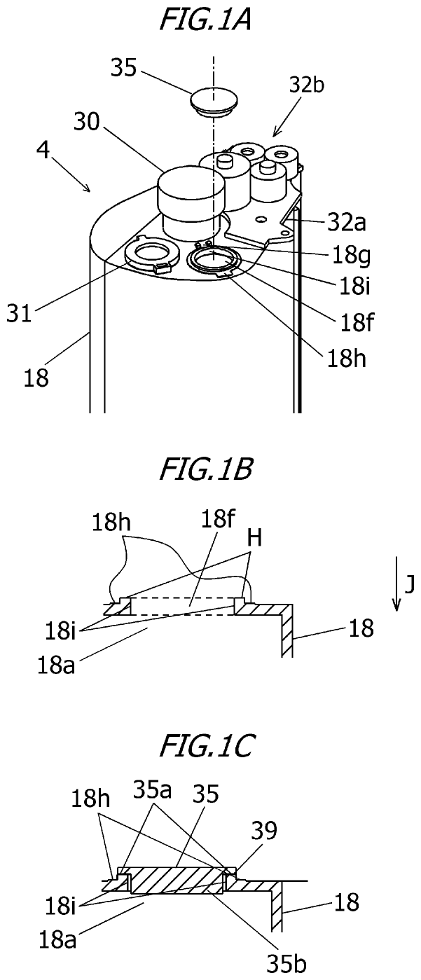

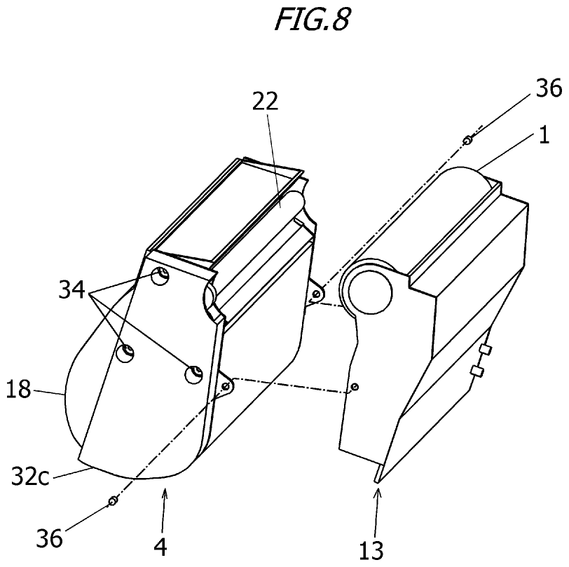

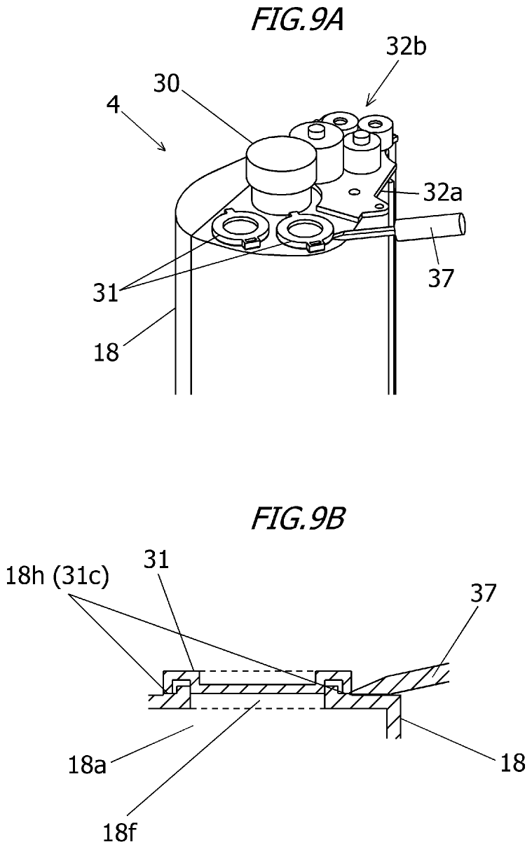

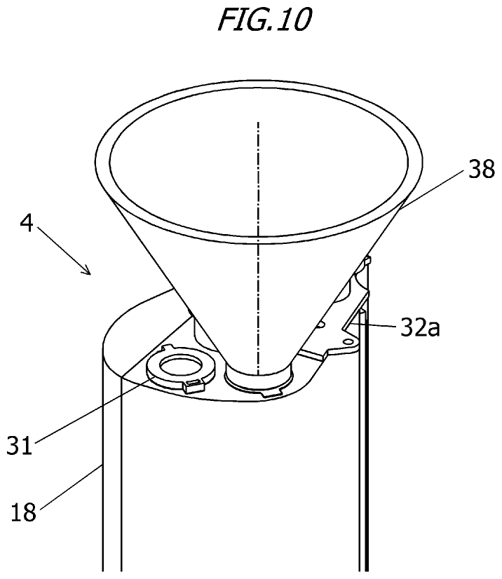

Next, a disassembling method and a remanufacturing method for the process cartridge 7 will be described in detail with reference to FIGS. 1A to 1C and FIGS. 5A to 10. FIG. 1A is a perspective view of the developing frame 18 before the new toner cap 35 is attached to the developing frame 18. FIG. 1B is a cross-sectional view of the toner filling port 18f before the new toner cap 35 is attached to the developing frame 18. FIG. 1C is a cross-sectional view of the toner filling port 18f after the new toner cap 35 has been attached. The new toner cap 35 is a cap member (second cap member) different from the toner cap 31. FIG. 8 is a perspective view of the process cartridge 7 in a step of separation into the photosensitive unit 13 and the developing unit 4. FIG. 9A is a perspective view of the developing unit 4 in an example of a step of removing the toner cap 31 from the developing frame 18. FIG. 9B is a cross-sectional view of the toner filling port 18f in an example of a step of removing the toner cap 31 from the developing frame 18. FIG. 10 is a perspective view of the developing unit 4 in a step of filling the toner. In the remanufacturing method according to the first embodiment, the toner is refilled from the toner filling port 18f. Therefore, it is not necessary to make a hole in the developing frame 18 to form a new toner filling port. Therefore, as compared with the case where a hole is made in the developing frame 18, the generation of scraps of the developing frame 18 can be suppressed. In addition, it is possible to prevent the internal parts such as the stirring member 23 from being damaged.

The remanufacturing method according to the first embodiment includes the following steps 1 to 7.

Step 1: step of separating the photosensitive unit 13 and the developing unit 4

Step 2: step of separating the side cover 32c

Step 3: step of removing the toner cap 31

Step 4: toner filling step (or toner refilling step)

Step 5: step of attaching the new toner cap 35 (sealing step or resealing step)

Step 6: step of reattaching the side cover 32c

Step 7: step of reassembling the photosensitive unit 13 and the developing unit 4

The remanufacturing method according to the first embodiment includes a preparation step of preparing the developing unit 4 (or the process cartridge 7) as a source component (a material component) before performing the abovementioned steps 1 to 7. For example, a used developing unit 4 (or a used process cartridge 7) after the toner has been consumed by performing image forming operations is used as the developing unit 4 (or the process cartridge 7) serving as the source component. In other words, the remanufacturing method according to the first embodiment is a method of remanufacturing a new developing unit (second developing device) from the developing unit 4 (first developing device) as the source component (a source developing unit or a material developing unit). Furthermore, in other words, the remanufacturing method according to the first embodiment is a method of remanufacturing a new process cartridge (second process cartridge) from the process cartridge 7 (first process cartridge) as the source component (a source cartridge or a material cartridge). Hereinafter, the abovementioned seven steps will be described in order.

Step 1

The step 1 is a step of separating the photosensitive unit 13 and the developing unit 4. The step of separating the photosensitive unit 13 and the developing unit 4 of the process cartridge 7 will be described with reference to FIG. 8. Joining pins 36 that join the photosensitive unit 13 and the developing unit 4 are pulled out from the respective holes provided in the photosensitive unit 13 and the developing unit 4, and the photosensitive unit 13 and the developing unit 4 are separated. The photosensitive unit 13 and the developing unit 4 are joined together by inserting the joining pins 36 into the respective holes provided in the photosensitive unit 13 and the developing unit 4 before performing the abovementioned first step.

Step 2

The step 2 is a step of separating the side cover 32c. The three screws 34 shown in FIG. 8 are removed from the developing unit 4 with a driver or the like, and the side cover 32c is removed from the developing unit 4.

Step 3

The step 3 is a step of removing the toner cap 31 (removing step or peeling step). At least one of a plurality of toner caps 31 is removed. As described above, since the toner cap 31 is adhesively bonded to the developing frame 18, the toner cap cannot be easily separated. Therefore, as shown in FIGS. 9A and 9B, a flathead screwdriver 37 or the like is inserted between the cap-side adhesive surface 31c and the frame-side adhesive surface 18h (see FIGS. 5A, 5B and 6A, 6B) in order to remove the toner cap 31 from the developing frame 18. Then, the toner cap 31 is peeled off from the cap-side adhesive surface 31c using the principle of lever or the like. Alternatively, the toner cap 31 may be peeled off from the cap-side adhesive surface 31c by pulling the toner cap with a pliers (not shown) or the like. Alternatively, the toner cap 31 may be broken and removed by an ultrasonic cutter (not shown) or laser processing (not shown). In the step of removing the toner cap 31, a method for removing the toner cap 31 is not limited. By this step, the cap-side adhesive surface 31c and the frame-side adhesive surface 18h are separated, and the toner cap 31 is peeled off from the frame-side adhesive surface 18h of the developing frame 18. At this time, a rough surface is formed on the frame-side adhesive surface 18h by removing the toner cap 31. The formation of the rough surface can be attributed to scratches on the frame-side adhesive surface 18h, an adhesive remaining on the frame-side adhesive surface 18h, a part of the toner cap 31 remaining on the frame-side adhesive surface 18h, and the like.

Step 4

The step 4 is a toner filling step in which the developing frame 18 is filled with a new toner. In the step 4, the developing frame 18 is preferably held so that the toner filling port 18f exposed by performing the step 3 is on the upper side in the vertical direction and the developer accommodating chamber 18a is on the lower side in the vertical direction, as shown in FIG. 10. A funnel 38 is inserted into the toner filling port 18f, and the toner is dropped from a toner bottle (not shown) or the like into the funnel 38, whereby the toner is refilled from the toner filling port 18f to the developer accommodating chamber 18a (see FIG. 4).

Step 5

The step 5 is a step of attaching the new toner cap 35. As shown in FIG. 1A, the toner filling port 18f exposed by performing the step 3 is sealed with the new toner cap 35. Thus, the step 5 is also a step of sealing the toner filling port 18f. Since welding marks remain on the frame-side adhesive surface 18h of the developing frame 18, and the surface of the frame-side adhesive surface 18h is rough, it is not easy to reattach the new toner cap 35 to the frame-side adhesive surface 18h. Therefore, as shown in FIG. 1B, the new toner cap 35 is adhesively bonded to a region H (second region) located on the inner side (in the first embodiment, the radially inner side of the toner filling port 180 of the original adhesive surface (frame-side adhesive surface 18h) on the outer surface of the developing frame 18. In other words, the new toner cap 35 is adhesively bonded to the region H located closer to the toner filling port 18f than the frame-side adhesive surface 18h on the outer surface of the developing frame 18. An adhesive member 39 is used to bond the new toner cap 35. An adhesive, a pressure-sensitive adhesive, a double-sided tape, a silicon bond, or the like is used for the adhesive member 39.

A step of bonding the new toner cap 35 to the region H of the developing frame 18 will be described hereinbelow. First, the adhesive member 39 is applied or affixed to the region H of the developing frame 18. Alternatively, the adhesive member 39 is applied or affixed to a predetermined portion of the new toner cap 35. The predetermined portion of the new toner cap 35 is a portion corresponding to the region H of the developing frame 18. Next, the new toner cap 35 is attached to the developing frame 18. Thus, the new toner cap 35 is adhesively bonded to the region H on the outer surface of the developing frame 18, and the toner filling port 18f is sealed with the new toner cap 35. As a result, as shown in FIG. 1C, the toner filling port 18f exposed by performing the step 3 can be sealed with the new toner cap 35 without the toner leaking from the developing frame 18.

As shown in FIG. 1B, in the state where the developing roller 22 is attached to the developing frame 18, the axial direction of the rotation center of the developing roller 22 is taken as the J direction. In the J direction shown in FIG. 1B, the height of the frame-side adhesive surface 18h of the developing frame 18 may be different from the height of the region H of the developing frame 18. In the J direction shown in FIG. 1B, the height of the region H of the developing frame 18 may be larger than the height of the frame-side adhesive surface 18h of the developing frame 18. Further, in the J direction shown in FIG. 1B, the height of the frame-side adhesive surface 18h of the developing frame 18 may be larger than the height of the region H of the developing frame 18. Thus, the developing frame 18 may have a step height between the frame-side adhesive surface 18h of the developing frame 18 and the region H of the developing frame 18. By providing the step height between the frame-side adhesive surface 18h of the developing frame 18 and the region H of the developing frame 18, the adhesive member 39 can be accurately applied or affixed to the region H of the developing frame 18. When there is no step height between the frame-side adhesive surface 18h of the developing frame 18 and the region H of the developing frame 18, a boundary between the frame-side adhesive surface 18h of the developing frame 18 and the region H of the developing frame 18 is difficult to confirm visually. Meanwhile, when there is a step height between the frame-side adhesive surface 18h of the developing frame 18 and the region H of the developing frame 18, the boundary between the frame-side adhesive surface 18h of the developing frame 18 and the region H of the developing frame 18 is easy to confirm visually. For this reason, the accuracy of application or attachment of the adhesive member 39 to the region H of the developing frame 18 is improved.

As shown in FIG. 1C, the new toner cap 35 has an adhesive surface 35a with the region H of the developing frame 18 and a protruding portion 35b that protrudes beyond the adhesive surface 35a. The adhesive member 39 is not applied or affixed to the protruding portion 35b. Therefore, the protruding portion 35b is a portion of the new toner cap 35 which is not adhesively bonded to the region H of the developing frame 18. In the step 5, the protruding portion 35b of the new toner cap 35 is inserted into the toner filling port 18f. By inserting the protruding portion 35b of the new toner cap 35 into the toner filling port 18f, the positional deviation between the new toner cap 35 and the developing frame 18 is suppressed. Therefore, the horizontal movement of the new toner cap 35 with respect to the outer surface of the developing frame 18 is restricted, and leakage of the toner from the gap between the new toner cap 35 and the developing frame 18 is suppressed.

Further, the toner filling port 18f may be sealed using the following alternative method. In the first alternative method, the adhesive surface corresponding to the region H of the developing frame 18 is provided in advance on the new toner cap 35 by using a material having a pressure-sensitive adhesive surface to configure the new toner cap 35. The toner filling port 18f may be sealed by attaching a new toner cap 35 having the adhesive surface to the developing frame 18. In the second alternative method, the toner filling port 18f may be sealed by attaching the new toner cap 35 to the developing frame 18, then pouring a terpene-based solvent (not shown) into the region H of the developing frame 18, and bonding the new toner cap 35 to the developing frame 18. In the third alternative method, the new toner cap 35 may be adhesively bonded to the developing frame 18 by attaching the new toner cap 35 to the developing frame 18, and then performing thermal welding, ultrasonic welding, laser welding or the like in the region H of the developing frame 18. Thus, the toner filling port 18f may be sealed by bonding the new toner cap 35 to the developing frame 18.

Step 6

The step 6 is a step of reattaching the side cover 32c. The side cover 32c removed from the developing unit 4 in the step 2 is reattached to the developing unit 4 in the procedure reversed with respect to the step 2. For example, the side cover 32c is reattached to the developing unit 4 by aligning the developing frame 18 and the side cover 32c and attaching the screw 34 to the developing unit 4 with a driver or the like.

Step 7

The step 7 is a step of reassembling the photosensitive unit 13 and the developing unit 4. The photosensitive unit 13 separated in the step 1 and the developing unit 4 refilled with the toner are reassembled in the procedure reversed with respect to the step 1. For example, alignment between the photosensitive unit 13 and the developing unit 4 is performed so that the hole provided in the photosensitive unit 13 and the hole provided in the developing unit 4 overlap. Thereafter, the joining pin 36 is inserted into the holes respectively provided in the photosensitive unit 13 and the developing unit 4 so that the photosensitive unit 13 and the developing unit 4 refilled with the toner are reassembled (rejoined). By performing the steps 1 to 7 described above, it is possible to remanufacture the process cartridge 7 while suppressing the leakage of the toner from the developing frame 18 and suppressing the deterioration of quality of the process cartridge 7.

In the first embodiment, polystyrene (PS) is used as the styrene-based resin composition. However, in place of PS, high-impact polystyrene (HIPS), acrylonitrile-butadiene-styrene copolymer (ABS) or the like may be used as the styrene-based resin composition. Further, examples of the terpene-based solvent used in the first embodiment include d-limonene, l-limonene, dl-limonene, d-α-pinene, d-3-pinene, α-terpinene, β-terpinene, and γ-terpinene. Further, terpinolene, 2-carene, d-3-carene, 1-3-carene and phellandrene can also be used as the terpene-based solvent. As the terpene-based solvent, it is preferable to use d-limonene, l-limonene and dl-limonene, and it is more preferable to use d-limonene.

Further, in the first embodiment, the new toner cap 35 is bonded to the region H which is on the radially inner side of the toner filling port 18f with respect to the original adhesive surface (frame-side adhesive surface 18h) of the developing frame 18. However, the new toner cap 35 may be bonded to a portion on the outer side with respect to the original adhesive surface (frame-side adhesive surface 18h) of the developing frame 18. In other words, the new toner cap 35 may be bonded to a region located farther from the toner filling port 18f than the frame-side adhesive surface 18h on the outer surface of the developing frame 18. Thus, the new toner cap 35 may be bonded to a portion (the second region of the developing frame 18) different from the original adhesive surface (the first region of the developing frame 18) of the developing frame 18. In addition, the scope of the present invention is not intended to be limited only to the functions, materials, shapes, relative positions, processes, etc. of the components described in the first embodiment, unless specified otherwise.

### Second Embodiment

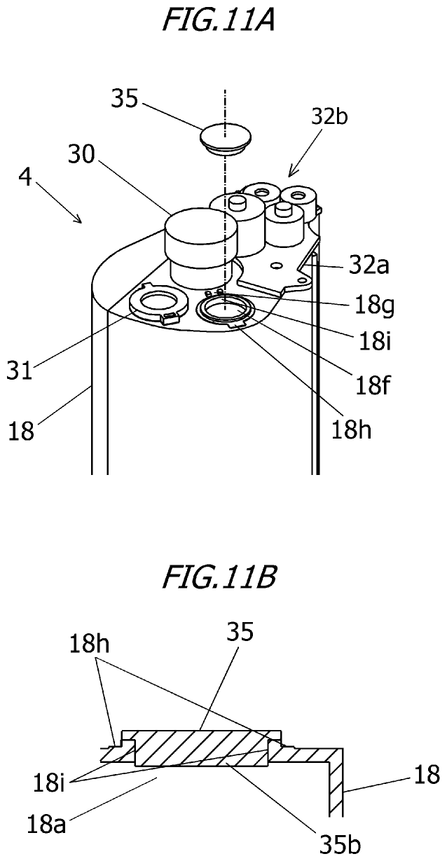

Next, the second embodiment according to the present invention will be described using FIGS. 11A and 11B. In the second embodiment, parts different from those in the first embodiment will be described in detail. The materials and shapes of the components of the second embodiment, the steps of the second embodiment, and the like are the same as those of the first embodiment unless stated otherwise. Components in the second embodiment which are the same as in the first embodiment are assigned with the same reference numerals and detailed description thereof is herein omitted. FIG. 11A is a perspective view of the developing frame 18 before the new toner cap 35 is attached to the developing frame 18. FIG. 11B is a cross-sectional view of the toner filling port 18f after the new toner cap 35 has been attached to the developing frame 18. The step 5 of the second embodiment is different from the step 5 of the first embodiment, whereas other steps of the second embodiment are the same as the other steps of the first embodiment.

Step 5

The step 5 of the second embodiment is a step of attaching the new toner cap 35. As shown in FIG. 11A, the toner filling port 18f exposed by performing the step 3 is sealed with the new toner cap 35. Here, since welding marks remain on the frame-side adhesive surface 18h of the developing frame 18, and the surface of the frame-side adhesive surface 18h is rough, the new toner cap 35 cannot be easily bonded again to the frame-side adhesive surface 18h. Therefore, as shown in FIG. 11B, the protruding portion 35b of the new toner cap 35 is press-fitted into the toner filling port 18f. That is, pressure is applied to the toner cap 35 in a state where the protruding portion 35b of the new toner cap 35 is in contact with an inner wall 18i of the toner filling port 18f, and the protruding portion 35b of the new toner cap 35 is inserted into the toner filling port 18f. By inserting the protruding portion 35b of the new toner cap 35 into the toner filling port 18f, the positional deviation between the new toner cap 35 and the developing frame 18 is suppressed. Therefore, the horizontal movement of the new toner cap 35 with respect to the outer surface of the developing frame 18 is restricted, and leakage of the toner from the gap between the new toner cap 35 and the developing frame 18 is suppressed. Furthermore, since the protruding portion 35b of the new toner cap 35 is in contact with the inner wall 18i of the toner filling port 18f, the gap between the inner wall 18i of the toner filling port 18f and the protruding portion 35b of the new toner cap 35 is eliminated. As a result, the toner leakage from the developing frame 18 is further suppressed, and the toner filling port 18f exposed by performing the step 3 can be sealed with the new toner cap 35. By performing the steps 1 to 7 described above, it is possible to remanufacture the process cartridge 7 while suppressing the leakage of the toner from the developing frame 18 and suppressing the deterioration of quality of the process cartridge 7. In addition, since the bonding step is unnecessary, it is possible to reduce the number of man-hours for remanufacturing the process cartridge 7.

In the second embodiment, low-density polyethylene is used as the material of the new toner cap 35, but the material of the new toner cap 35 is not limited. When the new toner cap 35, such as in this example, is pressed-fitted into the toner filling port 18f to seal the toner filling port 18f, from the viewpoint of stability of the seal and prevention of whitening, it is preferable that the material of the new toner cap 35 be softer than the material of the developing frame 18. In addition, the scope of the present invention is not intended to be limited only to the functions, materials, shapes, relative positions, processes, etc. of the components described in the second embodiment, unless specified otherwise.

### Third Embodiment

### Process Cartridge Disassembling Method and Remanufacturing Method

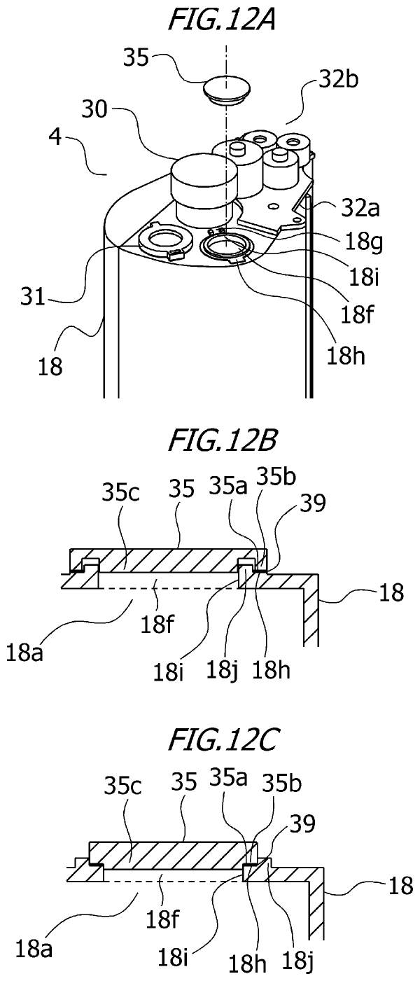

Next, a disassembling method and a remanufacturing method for the process cartridge 7 will be described in detail with reference to FIGS. 12A to 12C and FIGS. 5A to 10. FIG. 12A is a perspective view of the developing frame 18 before the new toner cap 35 is attached to the developing frame 18. FIGS. 12B and 12C are cross-sectional views of the toner filling port 18f after the new toner cap 35 has been attached. The new toner cap 35 is a cap member (second cap member) different from the toner cap 31. The new toner cap 35 is also a sealing member for sealing the toner filling port 18f. As in the first embodiment, in the remanufacturing method according to the third embodiment, the toner is refilled from the toner filling port 18f. Therefore, it is not necessary to make a hole in the developing frame 18 to form a new toner filling port. Therefore, as compared with the case where a hole is made in the developing frame 18, the generation of scraps of the developing frame 18 can be suppressed. In addition, it is possible to prevent the internal parts such as the stirring member 23 from being damaged.

The remanufacturing method according to the third embodiment includes the following steps 1 to 7.

Step 1: step of separating the photosensitive unit 13 and the developing unit 4

Step 2: step of separating the side cover 32c

Step 3: step of removing the toner cap 31

Step 4: toner filling step (or toner refilling step)

Step 5: step of attaching the new toner cap 35 (sealing step or resealing step)

Step 6: step of reattaching the side cover 32c

Step 7: step of reassembling the photosensitive unit 13 and the developing unit 4

As in the first embodiment, the remanufacturing method according to the third embodiment includes a preparation step of preparing the developing unit 4 (or the process cartridge 7) as the source component (the material component) before performing the abovementioned steps 1 to 7. The developing unit 4 (or the process cartridge 7), which is the source component, is the same as that of the first embodiment, so the description thereof will be omitted. Hereinafter, the above steps will be described in order. However, since the steps 1 to 4, step 6 and step 7 are the same as in the first embodiment, the description thereof will be omitted in this example.

Step 5

The step 5 is a step of attaching the new toner cap 35. As shown in FIG. 12A, the toner filling port 18f exposed by performing the step 3 is sealed with the new toner cap 35. Thus, step 5 is also the step of sealing the toner filling port 18f. Since welding marks remain on the frame-side adhesive surface 18h of the developing frame 18 and the surface of the frame-side adhesive surface 18h is rough, the new toner cap 35 cannot be easily bonded again to the frame-side adhesive surface 18h. Therefore, as shown in FIG. 12B, an elastic adhesive 39 is applied or affixed to the original adhesive surface (frame-side adhesive surface 18h) on the outer surface of the developing frame 18 or the adhesive surface 35a of the new toner cap 35. The elastic adhesive 39 is an adhesive having rubber elasticity even after curing. It is preferable that the elastic adhesive 39 have a degree of elasticity that allows the new toner cap 35 to move slightly with respect to the frame-side adhesive surface 18h due to the deformation of the elastic adhesive 39. Further, the elastic adhesive 39 may be coated so that the new toner cap 35 does not come in direct contact with the frame-side adhesive surface 18h. The elastic adhesive 39 may be, for example, a silicone bond which is a silicone-based adhesive. Further, the elastic adhesive 39 is not limited to a silicone-based adhesive, and may be a rubber-based, vinyl-based or urethane-based adhesive. Next, the new toner cap 35 is attached to the developing frame 18. Thus, the new toner cap 35 is bonded to the frame-side adhesive surface 18h on the outer surface of the developing frame 18 by the elastic adhesive 39, and the toner filling port 18f is sealed with the new toner cap 35. As a result, as shown in FIG. 12B, the toner filling port 18f exposed by performing the step 3 can be sealed with the new toner cap 35 without the toner leaking from the developing frame 18. Even when the surface of the frame-side adhesive surface 18h is rough, the elastic adhesive 39 absorbs the surface roughness of the frame-side adhesive surface 18h, so that the new toner cap 35 can be securely attached to the developing frame 18.

As shown in FIG. 12B, the new toner cap 35 has a protruding portion 35b provided on the outer peripheral portion of the new toner cap 35 and a protruding portion 35c provided on the central portion of the new toner cap 35. In the configuration example of the new toner cap 35 shown in FIG. 12B, a groove (a gap) is provided between the protruding portion 35b and the protruding portion 35c of the toner cap 35. The protruding portion 35b is an example of the first protruding portion. The protruding portion 35b of the new toner cap 35 protrudes toward the developing frame 18 and can be bonded to the frame-side adhesive surface 18h through the elastic adhesive 39. The protruding portion 35b of the new toner cap 35 protrudes toward the developing frame 18 and can be inserted into the toner filling port 18f. The developing frame 18 has a protruding portion 18j that protrudes outward. The protruding portion 18j is an example of the second protruding portion. The protruding portion 18j of the developing frame 18 protrudes in the opposite direction to the inside of the developer accommodating chamber 18a. In the step 5, the protruding portion 35b of the new toner cap 35 is bonded to the frame-side adhesive surface 18h in a state where a part of the side surface (inner side surface) of the protruding portion 35b of the new toner cap 35 and a part of the side surface (outer side surface) of the protruding portion 18j of the developing frame 18 face each other. As a consequence, the horizontal movement of the new toner cap 35 with respect to the outer surface of the developing frame 18 is restricted, and the positional deviation between the developing frame 18 and the new toner cap 35 is restricted. As a result, removing of the elastic adhesive 39 from the new toner cap 35 is suppressed, and leakage of the toner from the gap between the new toner cap 35 and the developing frame 18 is suppressed. Further, the protruding portion 35b of the new toner cap 35 may be bonded to the frame-side adhesive surface 18h in a state where a part of the side surface (inner side surface) of the protruding portion 35b of the new toner cap 35 is in contact with a part of the side surface (outer side surface) of the protruding portion 18j of the developing frame 18. In the example shown in FIG. 12B, the protruding portion 18j of the developing frame 18 is disposed so as to surround the toner filling port 18f when viewed in the normal direction of the opening surface of the toner filling port 18f. Further, in the example shown in FIG. 12B, the protruding portion 35b of the new toner cap 35 is disposed so as to surround the protruding portion 18j of the developing frame 18 when viewed in the normal direction of the opening surface of the toner filling port 18f. Therefore, in the step 5, the protruding portion 35b of the new toner cap 35 is disposed farther from the toner filling port 18f than the protruding portion 18j of the developing frame 18 when viewed in the normal direction of the opening surface of the toner filling port 18f.

Further, in the step 5, the protruding portion 35c of the new toner cap 35 is inserted into the toner filling port 18f. By inserting the protruding portion 35c of the new toner cap 35 into the toner filling port 18f, the positional deviation between the new toner cap 35 and the developing frame 18 is suppressed. Therefore, the horizontal movement of the new toner cap 35 with respect to the outer surface of the developing frame 18 is restricted, and removing of the elastic adhesive 39 from the new toner cap 35 is restricted. As a result, the leakage of the toner from the gap between the new toner cap 35 and the developing frame 18 is suppressed.

Further, a protruding portion 35c of the new toner cap 35 may be pressed-fitted into the toner filling port 18f. That is, a pressure may be applied to the toner cap 35, and the protruding portion 35c of the new toner cap 35 may be inserted into the toner filling port 18f in a state where the protruding portion 35c of the new toner cap 35 is in contact with the inner wall 18i of the toner filling port 18f. When the protruding portion 35c of the new toner cap 35 is in contact with the inner wall 18i of the toner filling port 18f, the gap between the inner wall 18i of the toner filling port 18f and the protruding portion 35c of the new toner cap 35 is eliminated. As a result, the toner leakage from the developing frame 18 is further suppressed.

In the example shown in FIGS. 12A and 12B, the protruding portion 35b of the new toner cap 35 is bonded to the frame-side adhesive surface 18h in a state where the inner side surface of the protruding portion 35b of the new toner cap 35 and the outer side surface of the protruding portion 18j of the developing frame 18 face each other. As shown in FIG. 12C, in the step 5, the protruding portion 35b of the new toner cap 35 may be bonded to the frame-side adhesive surface 18h in a state where the outer side surface of the protruding portion 35b of the new toner cap 35 and the inner side surface of the protruding portion 18j of the developing frame 18 face each other. As a result, the horizontal movement of the new toner cap 35 with respect to the outer surface of the developing frame 18 is restricted, and positional deviation between the new toner cap 35 and the developing frame 18 is restricted. As a result, removing of the elastic adhesive 39 from the new toner cap 35 is suppressed, and leakage of the toner from the gap between the new toner cap 35 and the developing frame 18 is suppressed. In the example shown in FIG. 12C, the protruding portion 35b of the new toner cap 35 is disposed so as to surround the toner filling port 18f when viewed in the normal direction of the opening surface of the toner filling port 18f. Further, in the example shown in FIG. 12C, the protruding portion 18j of the developing frame 18 is disposed so as to surround the protruding portion 35b of the new toner cap 35 when viewed in the normal direction of the opening surface of the toner filling port 18f. Therefore, in the step 5, the protruding portion 35b of the new toner cap 35 is disposed closer to the toner filling port 18f than the protruding portion 18j of the developing frame 18 when viewed in the normal direction of the opening surface of the toner filling port 18f. In the configuration example of the new toner cap 35 shown in FIG. 12C, a step height is provided between the protruding portion 35b and the protruding portion 35c of the new toner cap 35.

In the third embodiment, low-density polyethylene is used as the material of the new toner cap 35, but the material of the new toner cap 35 is not limited. When the new toner cap 35 such as in this example is pressed-fitted into the toner filling port 18f to seal the toner filling port 18f, from the viewpoint of stability of the seal and prevention of whitening, it is preferable that the material of the new toner cap 35 be softer than the material of the developing frame 18. In addition, the scope of the present invention is not intended to be limited only to the functions, materials, shapes, relative positions, processes, etc. of the components described in the third embodiment, unless specified otherwise.

### Fourth Embodiment

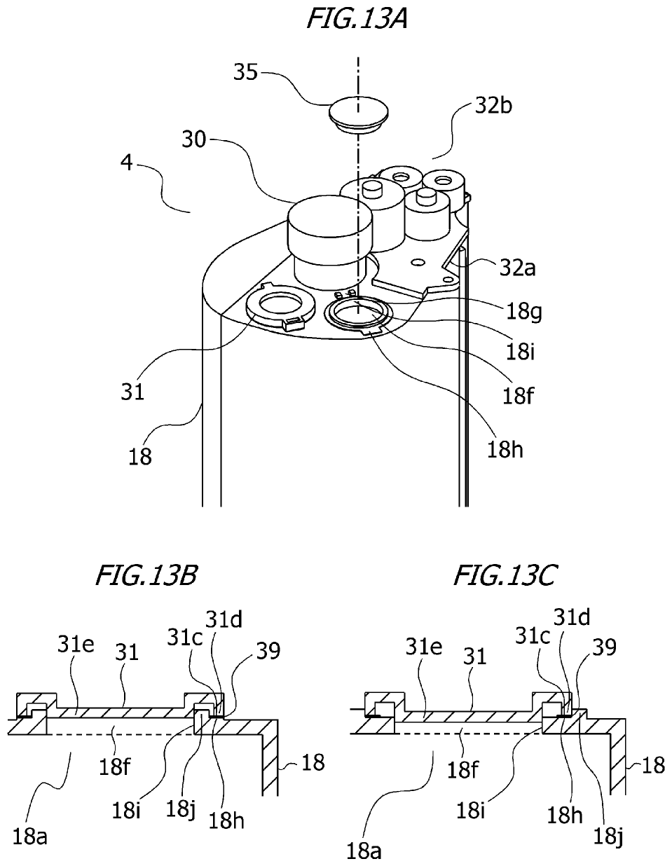

Next, the fourth embodiment according to the present invention will be described using FIGS. 13A to 13C. In the fourth embodiment, parts different from those in the third embodiment will be described in detail. The materials and shapes of the components of the fourth embodiment, the steps of the fourth embodiment, and the like are the same as those of the third embodiment unless stated otherwise. Components in the fourth embodiment which are the same as in the third embodiment are assigned with the same reference numerals and detailed description thereof is herein omitted. FIG. 13A is a perspective view of the developing frame 18 before the toner cap 31 removed in the step 3 is reattached to the developing frame 18. FIGS. 13B and 13C are cross-sectional views of the toner filling port 18f after the toner cap 31 removed in the step 3 has been reattached to the developing frame 18. The step 5 of the fourth embodiment is different from the step 5 of the third embodiment, whereas other steps of the fourth embodiment are the same as the other steps of the third embodiment.

Step 5

The step 5 of the fourth embodiment is a reattachment step of the toner cap 31 removed in step 3 (hereinafter referred to as removed toner cap 31). As shown in FIG. 13A, the toner filling port 18f exposed by performing the step 3 is sealed with the removed toner cap 31. That is, the removed toner cap 31 is used as a sealing member for sealing the toner filling port 18f. Here, since welding marks remain on the frame-side adhesive surface 18h of the developing frame 18, and the surface of the frame-side adhesive surface 18h is rough, the removed toner cap 31 cannot be easily bonded again to the frame-side adhesive surface 18h. Therefore, as shown in FIG. 13B, the elastic adhesive 39 is applied or affixed to the original adhesive surface (frame-side adhesive surface 18h) on the outer surface of the developing frame 18 or the cap-side adhesive surface 31c of the removed toner cap 31. Next, the removed toner cap 31 is reattached to the developing frame 18. Thus, the removed toner cap 31 is bonded to the frame-side adhesive surface 18h on the outer surface of the developing frame 18 through the elastic adhesive 39, and the toner filling port 18f is sealed with the reattached toner cap 31. As a result, as shown in FIG. 13B, the toner filling port 18f exposed by performing the step 3 can be sealed by the reattached toner cap 31 without the toner leaking from the developing frame 18. Since the elastic adhesive 39 absorbs the surface roughness of the frame-side adhesive surface 18h, the removed toner cap 31 can be securely attached to the developing frame 18 even when the surface of the frame-side adhesive surface 18h is rough. By performing the steps 1 to 7 described above, it is possible to remanufacture the process cartridge 7 while suppressing the leakage of the toner from the developing frame 18 and suppressing the deterioration of quality of the process cartridge 7. In addition, since the bonding step is unnecessary, it is possible to reduce the number of man-hours for remanufacturing the process cartridge 7.

As shown in FIG. 13B, the toner cap 31 has a protruding portion 31d provided on the outer peripheral portion of the toner cap 31 and a protruding portion 31e provided in the central portion of the toner cap 31. In the configuration example of the toner cap 31 shown in FIG. 13B, a groove (a gap) is provided between the protruding portion 31d and the protruding portion 31e of the toner cap 31. The protruding portion 31d is an example of the first protruding portion. The protruding portion 31d of the toner cap 31 protrudes toward the developing frame 18 and can be bonded to the frame-side adhesive surface 18h through the elastic adhesive 39. The protruding portion 31e of the toner cap 31 protrudes toward the developing frame 18 and can be inserted into the toner filling port 18f. In the step 5, the protruding portion 31d of the removed toner cap 31 is bonded to the frame-side adhesive surface 18h in a state where a part of the side surface (inner side surface) of the protruding portion 31d of the removed toner cap 31 and a part of the side surface (outer side surface) of the protruding portion 18j of the developing frame 18 face each other. As a consequence, the horizontal movement of the reattached toner cap 31 with respect to the outer surface of the developing frame 18 is restricted, and the positional deviation between the reattached toner cap 31 and the developing frame 18 is restricted. As a result, removing of the elastic adhesive 39 from the reattached toner cap 31 is suppressed, and leakage of the toner from the gap between the reattached toner cap 31 and the developing frame 18 is suppressed. Further, the protruding portion 31d of the toner cap 31 may be bonded to the frame-side adhesive surface 18h in a state where a part of the side surface (inner side surface) of the protruding portion 31d of the removed toner cap 31 and a part of the side surface (outer side surface) of the protruding portion 18j of the developing frame 18 are in contact with each other. In the example shown in FIG. 13B, the protruding portion 18j of the developing frame 18 is disposed so as to surround the toner filling port 18f when viewed in the normal direction of the opening surface of the toner filling port 18f. Further, in the example shown in FIG. 13B, the protruding portion 31d of the reattached toner cap 31 is disposed so as to surround the protruding portion 18j of the developing frame 18 when viewed in the normal direction of the opening surface of the toner filling port 18f. Therefore, in the step 5, the protruding portion 31d of the reattached toner cap 31 is disposed farther from the toner filling port 18f than the protruding portion 18j of the developing frame 18 when viewed in the normal direction of the opening surface of the toner filling port 18f.

Further, the protruding portion 31e of the removed toner cap 31 may be pressed into the toner filling port 18f. That is, a pressure may be applied to the removed toner cap 31 and the protruding portion 31e of the removed toner cap 31 may be inserted into the toner filling port 18f in a state where the protruding portion 31e of the removed toner cap 31 is in contact with the inner wall 18i of the toner filling port 18f. When the protruding portion 31e of the removed toner cap 31 is in contact with the inner wall 18i of the toner filling port 18f, the gap between the inner wall 18i of the toner filling port 18f and the protruding portion 31e of the removed toner cap 31 is eliminated. As a result, the toner leakage from the developing frame 18 is further suppressed.

In the example shown in FIGS. 13A and 13B, the protruding portion 31d of the removed toner cap 31 is bonded to the frame-side adhesive surface 18h in a state where the inner side surface of the protruding portion 31d of the removed toner cap 31 and the outer side surface of the protruding portion 18j of the developing frame 18 face each other. As shown in FIG. 13C, in the step 5, the protruding portion 31d of the removed toner cap 31 may be bonded to the frame-side adhesive surface 18h in a state where the outer side surface of the protruding portion 31d of the removed toner cap 31 and the inner side surface of the protruding portion 18j of the developing frame 18 face each other. As a result, the horizontal movement of the reattached toner cap 31 with respect to the outer surface of the developing frame 18 is restricted, and positional deviation between the reattached toner cap 31 and the developing frame 18 is restricted. As a result, removing of the elastic adhesive 39 from the reattached toner cap 31 is suppressed, and leakage of the toner from the gap between the reattached toner cap 31 and the developing frame 18 is suppressed. In the example shown in FIG. 13C, the protruding portion 31d of the reattached toner cap 31 is disposed so as to surround the toner filling port 18f when viewed in the normal direction of the opening surface of the toner filling port 18f. Further, in the example shown in FIG. 13C, the protruding portion 18j of the developing frame 18 is disposed so as to surround the protruding portion 31d of the reattached toner cap 31 when viewed in the normal direction of the opening surface of the toner filling port 18f. Therefore, in the step 5, the protruding portion 31d of the reattached toner cap 31 is disposed closer to the toner filling port 18f than the protruding portion 18j of the developing frame 18 when viewed in the normal direction of the opening surface of the toner filling port 18f. In the configuration example of the toner cap 31 shown in FIG. 13C, a step height is provided between the protruding portion 31d and the protruding portion 31e of the toner cap 31.

In the fourth embodiment, low-density polyethylene may be used as the material of the toner cap 31. When the toner cap 31 such as in this example is pressed-fitted into the toner filling port 18f to seal the toner filling port 18f, from the viewpoint of stability of the seal and prevention of whitening, it is preferable that the material of the toner cap 31 be softer than the material of the developing frame 18. In addition, the scope of the present invention is not intended to be limited only to the functions, materials, shapes, relative positions, processes, etc. of the components described in the fourth embodiment, unless specified otherwise.

According to the present invention, it is possible to provide a remanufacturing method for a developing device and a process cartridge in which toner leakage is suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2018-160421, filed on Aug. 29, 2018, and Japanese Patent Application No. 2018-160576, filed on Aug. 29, 2018 which are hereby incorporated by reference herein in their entirety.

What is claimed is:

1. A remanufacturing method for remanufacturing a second developing device from a first developing device,
the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to a first region of the frame with a first adhesive capable of dissolving the frame, and
the remanufacturing method comprising:
a removing step of removing the first cap member from the first region such that a rough surface is formed in the first region;
a filling step of filling the developer accommodating chamber with the developer; and
a sealing step of bonding a second cap member different from the first cap member to a second region of the frame different from the first region to seal the opening with the second cap member.

2. The remanufacturing method according to claim 1, wherein
the second cap member has an adhesive surface with the second region, and a protruding portion, and
in the sealing step, the protruding portion is inserted into the opening.

3. The remanufacturing method according to claim 1, wherein
the second cap member has an adhesive surface with the second region, and a protruding portion, and
in the sealing step, the protruding portion is press-fitted into the opening.

4. The remanufacturing method according to claim 1, wherein
the second region is located closer to the opening than the first region.

5. The remanufacturing method according to claim 1, wherein
the second region is located farther from the opening than the first region.

6. The remanufacturing method according to claim 1, wherein
the frame has a step height between the first region and the second region.

7. A remanufacturing method for remanufacturing a second process cartridge from a first process cartridge,
the first process cartridge including a developing device including a frame provided with a developer accommodating chamber for accommodating a developer, the frame having an opening for communicating the developer accommodating chamber with the outside of the frame, and a first cap member configured to seal the opening, the first cap member being adhesively bonded to a first region of the frame with a first adhesive capable of dissolving the frame; and an image bearing member configured to bear a developer image, and
the remanufacturing method comprising:
a removing step of removing the first cap member from the first region such that a rough surface is formed in the first region;
a filling step of filling the developer accommodating chamber with the developer; and
a sealing step of bonding a second cap member different from the first cap member to a second region of the frame different from the first region to seal the opening with the second cap member.

8. The remanufacturing method according to claim 7, wherein
the second cap member has an adhesive surface with the second region, and a protruding portion, and
in the sealing step, the protruding portion is inserted into the opening.

9. The remanufacturing method according to claim 7, wherein
the second cap member has an adhesive surface with the second region, and a protruding portion, and
in the sealing step, the protruding portion is press-fitted into the opening.

10. The remanufacturing method according to claim 7, wherein
the second region is located closer to the opening than the first region.

11. The remanufacturing method according to claim 7, wherein
the second region is located farther from the opening than the first region.

12. The remanufacturing method according to claim 7, wherein
the frame has a step height between the first region and the second region.

13. A remanufacturing method for remanufacturing a second developing device from a first developing device,
the first developing device including a frame provided with a developer accommodating chamber for accommodating a developer, the frame having an opening for communicating the developer accommodating chamber with the outside of the frame; and a first cap member configured to seal the opening, the first cap member being adhesively bonded to an adhesive surface of the frame with a first adhesive capable of dissolving the frame, and
the remanufacturing method comprising:
a removing step of removing the first cap member from the adhesive surface such that a rough surface is formed on the adhesive surface;
a filling step of filling the developer accommodating chamber with the developer; and
a sealing step of bonding a sealing member to the adhesive surface with an elastic adhesive having elasticity to seal the opening with the sealing member.

14. The remanufacturing method according to claim 13, wherein
the sealing member has a first protruding portion that can be adhesively bonded to the adhesive surface with the elastic adhesive, and the frame has a second protruding portion that protrudes toward the outside of the frame; and
in the sealing step, the first protruding portion is adhesively bonded to the adhesive surface in a state where a part of a side surface of the first protruding portion and a part of a side surface of the second protruding portion face each other.

15. The remanufacturing method according to claim 14, wherein
in the sealing step, the first protruding portion is disposed farther from the opening than the second protruding portion when viewed in a normal direction of an opening surface of the opening.

16. The remanufacturing method according to claim 14, wherein
in the sealing step, the first protruding portion is disposed closer to the opening than the second protruding portion when viewed in a normal direction of an opening surface of the opening.

17. The remanufacturing method according to claim 13, wherein
the sealing member is a second cap member different from the first cap member.

18. The remanufacturing method according to claim 13, wherein
the sealing member is the first cap member.

19. A remanufacturing method for remanufacturing a second process cartridge from a first process cartridge,
the first process cartridge including a developing device including a frame provided with a developer accommodating chamber for accommodating a developer, the frame having an opening for communicating the developer accommodating chamber with the outside of the frame, and a first cap member configured to seal the opening, the first cap member being adhesively bonded to an adhesive surface of the frame with a first adhesive capable of dissolving the frame; and an image bearing member configured to bear a developer image, and
the remanufacturing method comprising:
a removing step of removing the first cap member from the adhesive surface such that a rough surface is formed on the adhesive surface;
a filling step of filling the developer accommodating chamber with the developer; and
a sealing step of bonding a sealing member to the adhesive surface with an elastic adhesive having elasticity to seal the opening with the sealing member.

20. The remanufacturing method according to claim 19, wherein
the sealing member has a first protruding portion that can be adhesively bonded to the adhesive surface with the elastic adhesive, and the frame has a second protruding portion that protrudes toward the outside of the frame; and
in the sealing step, the first protruding portion is adhesively bonded to the adhesive surface in a state where a part of a side surface of the first protruding portion and a part of a side surface of the second protruding portion face each other.

21. The remanufacturing method according to claim 20, wherein
in the sealing step, the first protruding portion is disposed farther from the opening than the second protruding portion when viewed in a normal direction of an opening surface of the opening.

22. The remanufacturing method according to claim 20, wherein
in the sealing step, the first protruding portion is disposed closer to the opening than the second protruding portion when viewed in a normal direction of an opening surface of the opening.

23. The remanufacturing method according to claim 19, wherein
the sealing member is a second cap member different from the first cap member.

24. The remanufacturing method according to claim 19, wherein
the sealing member is the first cap member.
